(19) United States
(12) Patent Application Publication
(10) Pub. No.: US 2009/0250567 A1
(43) Pub. Date: Oct. 8, 2009

(54) Compact Tripod

(76) Inventor: Guy Raynaud, La. Hayles Roses (FR)

Correspondence Address: RATNERPRESTIA, P.O. BOX 980, VALLEY FORGE, PA, 19482, US

(21) Appl. No.: 10/585,541

(22) PCT Filed: Jan. 3, 2005
(86) PCT No.: PCT/EP05/00022

§ 371 Date: Jul. 10, 2006

(30) Foreign Application Priority Data
Jan. 16, 2004 (IT) PD2004A/000005

(51) Int. Cl. F16M 11/38

(52) U.S. Cl. 248/168

(57) ABSTRACT

A compact tripod includes at least three legs converging on a spider and hinged thereto at one end by a corresponding hinge sleeve and fork member. A support is provided for a head mounted on the spider in a position such that it projects from the spider opposite the legs when the tripod is open in an operating position. The hinge sleeve and fork member are designed to allow the legs to be folded back from the part of the support when the tripod is closed in a non-operating position. Additionally, the hinge sleeve and fork member include a toothed element and a corresponding stop for the toothed element which are capable of interacting together to limit the extent by which the legs open with respect to the spider.

This application is a U.S. National Phase Application of PCT International Application PCT/EP2005/000022.

### TECHNICAL FIELD

This invention relates to a tripod, designed particularly but not exclusively for the support of optical and/or photographic equipment. In this context the term “tripod” is to be understood to indicate a support including at least three legs which converge in a spider to which the legs are hinged at one end.

### TECHNOLOGICAL BACKGROUND

Within this specific technical field a need has been felt to provide tripods which are particularly compact when closed into a carrying position.

On the other hand it is likewise required that tripods should extend to a maximum when open in the operating position. The two requirements are obviously conflicting.

In order to reconcile these two conditions, there have been tripods with telescopic legs with multiple sections or threaded portions which have minimum dimensions when in the closed position. The number of threaded portions on each leg is however limited, both by technical and dimensional reasons and by reasons of an economic nature. Legs with four or five telescopic sections generally represent the normal technical limit. In order to further reduce the dimensions of tripods in the closed position, arrangements have been designed which make it possible to partly retract the head support into the spider. The further benefit which can be achieved in this way is however relatively small.

An example of a conventional tripod is described in U.S. Pat. No. 4,886,230.

### BRIEF SUMMARY OF THE INVENTION

The technical problem considered by this invention is that of providing a tripod which is structurally and functionally designed to overcome all the disadvantages mentioned with reference to the known art while at the same time minimising dimensions in the closed position.

This problem has been overcome by the invention through a tripod which includes at least three legs converging in a spider to which the legs are hinged at one end through corresponding hinge means and counter-means. The tripod of the present invention includes a support for a head mounted in the spider in a position such that the support projects from the spider on a side opposite the legs when the tripod is open in an operating position. The hinge means and counter-means are designed to allow the legs to be folded back from that part of the support when the tripod is closed in a non-operating position. The hinge means and counter-means include toothed means and corresponding stop means for the toothed means which are capable of interacting together to limit the extent to which the legs open with respect to the spider.

### BRIEF DESCRIPTION OF THE DRAWINGS

The advantages and characteristics of the present invention will become clear from the following detailed description which is given with reference to the appended drawings which are provided purely by way of non-limiting example and in which:

FIG. 1 is a view in elevation of a tripod according to the invention in the open operating position (with legs retracted),

FIG. 2 is an identical view of the tripod in FIG. 1 in the closed non-operating position,

FIG. 3 is a perspective view on a magnified scale of a detail of the tripod in FIG. 2 (closed position),

FIGS. 4 and 5 are perspective views of the same detail in FIG. 3 in two different opening positions,

FIG. 6 is a view in axial cross-section of the tripod in the preceding figures in the closed position.

### PREFERRED EMBODIMENTS OF THE INVENTION

In the figures, 1 indicates as a whole a tripod mainly but not exclusively intended for the support of optical and/or photographic equipment constructed according to this invention.

Tripod 1 comprises three identical legs, all indicated by 2, converging on a spider 3 to the center of which a column 4 is movably attached. Column 4 has a support 5 at one end for a head 6 which is in turn provided with a plate 7 on which the equipment in use can be removably fixed. Plate 7 can be orientated within a substantially hemispherical space through a spherical joint which is not shown. One of the possible orientation positions is that shown in FIG. 2, with the tripod closed, to which reference will be made below.

Column 4 is movably guided within a central hub 8 of spider 3 and can be immobilized in an adjustable position through tightening a collar 9. On the side opposite head 6 the latter is provided with a disc-shaped stop 10 surrounded around its perimeter by a resilient elastic ring 11.

Spider 3 comprises three equally spaced arms 12 extending radially from hub 8 and each bearing a hinge sleeve 13. A fork member 15 which is shoed through a tubular length 16 onto the free end of the outermost section 17 (or portion) of corresponding leg 2 is hinged on sleeve 13 through a screw pin 14. Sleeve 13 and fork member 15 constitute respectively hinge means and counter means of each leg 2 to the spider 3.

Legs 2 comprise a plurality of sections or portions 18, 19, 20 and 21 which are telescopically inserted into each other and can be extracted through adjustable extension with the possibility of relative immobilization through corresponding collar locks 22 which are functionally identical to the one on column 4.

Between the tines 23 of fork member 15 there is a flat surface 24 on which a lever 25 is hinged through a screw 26. A plurality of teeth 27, 28 which are angularly offset with respect to each other and a cylindrical length 29 referred to below as the free length are provided on the outer mantle of hinge sleeve 13. Teeth 27, 28, the free length and hinging pin 14 are coaxial with each other.

Lever 25 can be moved by means of an operating appendage 30 which is accessible from outside the tripod when in the open position, into at least three operating positions in which its intermediate section bearing a shoulder 33 is positioned on the rotation trajectory of teeth 27, 28 or the free length in order to restrict the swing of legs 2 with respect to spider 3 acting as a stop for teeth 27, 28 or to permit legs 2 to rotate completely back on themselves when the aforesaid shoulder lies opposite cylindrical free length 29, against which it does not abut. Lever 25 is resiliently stressed by means of a spring, which is not shown, which acts between the same and surface 24 around screw 26, towards the engaging position with tooth 27 away from free length 29.

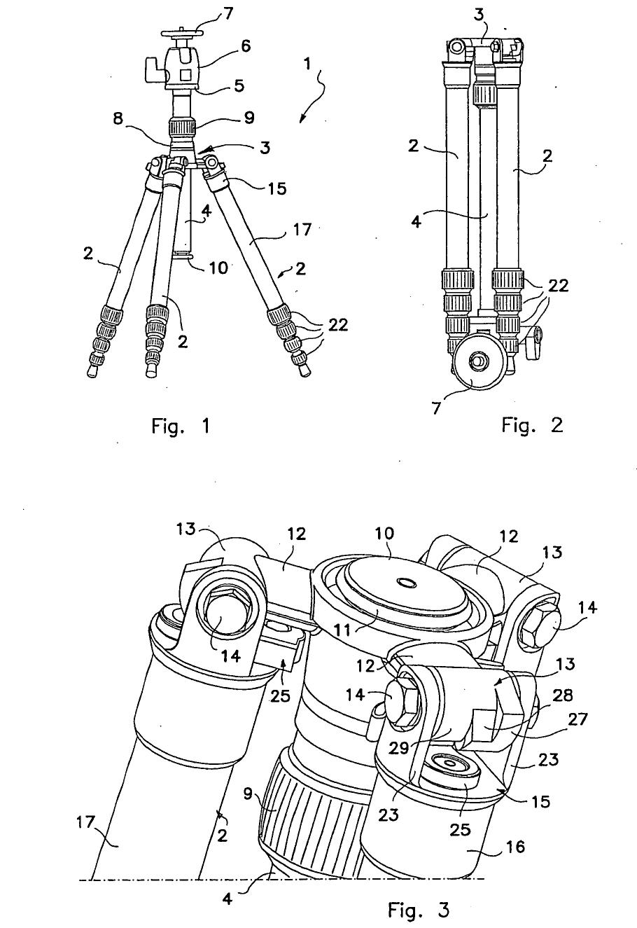

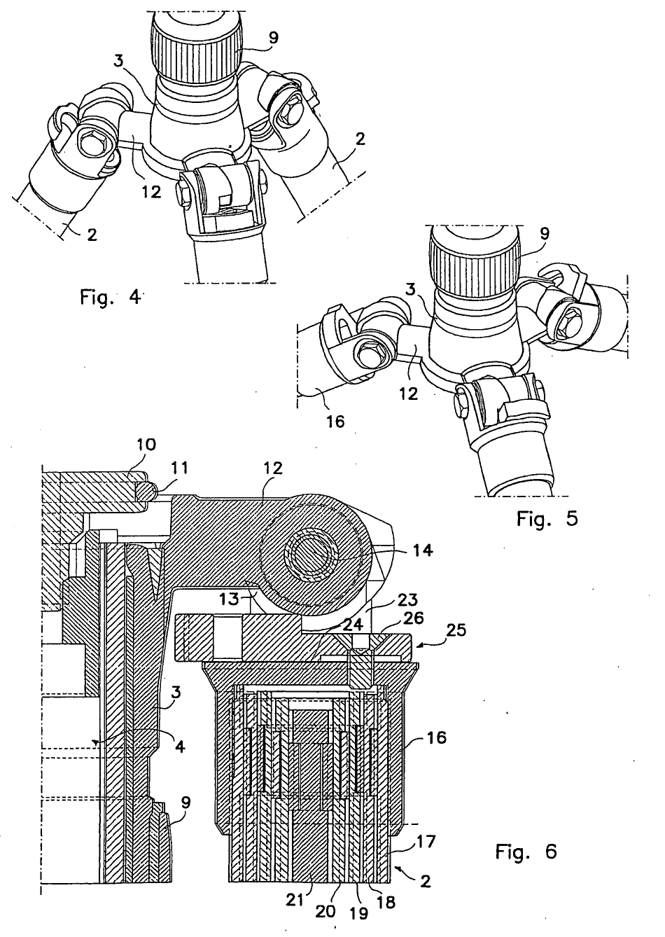

As a result of these structural and functional arrangements tripod 1 can be closed from the open operating position in FIG. 1 to a non-operating closed position of minimum dimensions illustrated in FIG. 2. The following actions are performed in order to change from one of these positions to the other. Starting from the open operating position in FIG. 1, in order to close the tripod column 4 is raised (contrary to what would be expected) into the position of maximum extension, the portions of legs 2 are collapsed telescopically one into another, the lever 25 of each leg is moved in such a way as to position it opposite free length 29 and the corresponding leg is rotated through an angle of more than 90° folding the leg to the same part of support 5 for head 6. In this position the spider and the head disappear completely between the legs of the tripod and do not therefore give rise to any additional dimensions of any kind.

Plate 7 is orientatable substantially at right angles with respect to the column so as to further minimize the overall dimensions in the closed position, at the same time maximizing the height of the tripod because in this way column 4 can have a longitudinal extension which is substantially identical to the extension of the legs.

The reverse operations are performed in order to open the tripod, swinging the legs around the spider to bring them onto the opposite side of head 6, restricting the opening of the same by appropriately positioning of lever 25 with respect to teeth 27, 28.

Obviously the system governing the amount by which the legs of the tripod open can be wholly different from the lever and teeth system illustrated so far without thereby adversely influencing the function of the invention.

The principal advantage of this tripod lies in maximizing the useful height in the open operating position with a concomitant reduction in dimensions in the closed position. In addition to this the tripod is of simple construction, light, easily transportable and easily adjustable in a few operations. Not least, it makes it possible to keep the head mounted on its support even when the tripod is closed, without interfering with the minimum dimensions.

1. A compact tripod including at least three legs converging in a spider to which the legs are hinged at one end through corresponding hinge means and counter means, and a support for a head mounted in the spider in a position such that the support projects from the spider on a side opposite the legs when the tripod is open in an operating position, and in which hinge means and counter-means are designed to allow the legs to be folded back from that part of the support when the tripod is closed in a non-operating position, and the hinge means and counter-means comprise toothed means and corresponding stop means for the toothed means which are capable of interacting together to limit the extent by which the legs open with respect to the spider.

2. The tripod according to claim 1 in which the hinge means and counter-means are designed to permit relative rotation between the legs and the spider through an angle of 90° or more.

3. The tripod according to claim 2 in which the hinge means and counter-means are designed to allow relative rotation between the legs and spider through an angle of between 90° and approximately 180°.

4. The tripod according to claim 1 in which the toothed means comprise a plurality of teeth angularly offset with respect to each other on the hinge means of one piece with the spider, the hinge means being a hinge sleeve, and the stop means comprise a lever with a shoulder which can be moved on the leg into positions such that it selectively abuts against one of the said teeth to limit the angle through which the leg opens.

5. The tripod according to claim 4 in which the teeth are positioned on projections coaxial with the hinge sleeve.

6. The tripod according to claim 4 in which a free length is provided on the hinge sleeve which does not interfere with the stop means so that when the stop means are positioned on the free length the legs can be folded back between the operating position and the non-operating position.

7. The tripod according to claim 4 in which the lever is provided with an operating appendage which is accessible from the side opposite the spider when the legs are in the operating position.

8. The tripod according to claim 4 in which the lever is resiliently stressed towards a position in which it engages with a tooth distance from the free length.

9. The tripod according to claim 1 in which the support is mounted on a column which is movably engaged in the spider in an adjustable manner.

10. The tripod according to claim 9 in which said head, fitted to the said support, is provided with a plate which can be orientated substantially at right angles with respect to an axis of the column when the tripod is closed in the non-operating position.

11. The tripod according to claim 2, in which the toothed means comprise a plurality of teeth angularly offset with respect to each other on the hinge means of one piece with the spider, the hinge means being a hinge sleeve, and the stop means comprise a lever with a shoulder which can be moved on the leg into positions such that it selectively abuts against one of the teeth to limit the angle through which the leg opens.

12. The tripod according to claim 3, in which the toothed means comprise a plurality of teeth angularly offset with respect to each other on the hinge means of one piece with the spider, the hinge means being a hinge sleeve, and the stop means comprise a lever with a shoulder which can be moved on the lea into positions such that it selectively abuts against one of the teeth to limit the angle through which the leg opens.

13. The tripod according to claim 5 in which a free length is provided on the hinge sleeve which does not interfere with the stop means so that when the stop means are positioned on the free length the legs can be folded back between the operating position and the non-operating position.

14. The tripod according to claim 5 in which the lever is provided with an operating appendage which is accessible from the side opposite the spider when the legs are in the operating position.

15. The tripod according to claim 6 in which the lever is provided with an operating appendage which is accessible from the side opposite the spider when the legs are in the operating position.

16. The tripod according to claim 5 in which the lever is resiliently stressed towards a position in which it engages with a tooth distance from the free length.

17. The tripod according to claim 6 in which the lever is resiliently stressed towards a position in which it engages with a tooth distance from the free length.

18. The tripod according to claim 7 in which the lever is resiliently stressed towards a position in which it engages with a tooth distance from the free length.

19. The tripod according to claim 2 in which the support is mounted on a column which is movably engaged in the spider in an adjustable manner.

20. The tripod according to claim 3 in which the support is mounted on a column which is movably engaged in the spider in an adjustable manner.
